(19) United States
(12) Patent Application Publication
(10) Pub. No.: US 2022/0078083 A1
(43) Pub. Date: Mar. 10, 2022

(54) METHODS FOR SELF-OPTIMIZING SYSTEMS

(71) Applicant: School Day Helsinki Oy, Helsinki (FI)

(72) Inventors: Mikko Kylväjä, Espoo (FI); Antero Pulli, Nummela (FI)

(73) Assignee: School Day Helsinki Oy, Helsinki (FI)

(21) Appl. No.: 17/012,169

(22) Filed: Sep. 4, 2020

(51) Int. Cl. H04L 12/24; H04W 16/28; G06N 3/08; H01Q 3/02

(52) U.S. Cl. CPC H04L 41/0886; H04L 41/0823; H01Q 3/02; G06N 3/08; H04W 16/28

(57) ABSTRACT

There is provided a method for self-optimizing a system implementing a process. The method uses a computing arrangement including a processing arrangement and data memory coupled thereto. The computing arrangement includes an output interface for interrogating the system, and an input interface and for receiving measurement responses from the system. The computing arrangement includes a mathematical model of the system to be self-optimized. The method includes using the computing arrangement to configure interrogating data for interrogating the system, and to apply the interrogating data to the system via the output interface. The method further includes using the computing arrangement to collect corresponding measurement response data from the system via the input interface. The method includes using the computing arrangement to compute from the measurement response data one or more measured indicators representing operation of the system. The method further includes using the computing arrangement to compare the one or more measured indicators (I) with one or more corresponding target indicators to compute one or more corresponding performance gaps, wherein the one or more performance gaps are used to select from the mathematical model one or more optimization routines for optimizing a performance of the system. The computing arrangement then applies the one or more optimization routines via the output interface to the system to optimize its performance.

### TECHNICAL FIELD

The present disclosure relates generally to methods for self-optimizing systems, for example the present disclosure relates to methods for automatically continuously self-optimizing systems. Moreover, the present disclosure also relates to apparatus that utilize the methods when in operation to optimize systems. Furthermore, the present disclosure relates to a computer program product comprising a non-transitory computer-readable storage medium having computer-readable instructions stored thereon, the computer-readable instructions being executable by a computerized device comprising processing hardware to execute the aforementioned methods.

### BACKGROUND

Contemporary known processes include, for example, industrial processes for manufacturing (for example in chemical facilities, assembly lines, in agriculture) or for providing services (for example, data supply services such as Internet® data streaming and wireless telecommunications services). Often, especially when the contemporary processes are complex in nature, it is not a straightforward task to devise improvements to the processes.

Therefore, there arises a need for an improved method for automatically continuously self-optimizing systems that are used to implement processes. Such optimization is required to be performed without changing a core functionality of the systems or disrupting a functionality provided by the systems.

In a granted US patent U.S. Ser. No. 10/606,337B2 “Techniques for self-tuning of computer systems” (Applicant: The Joan and Irwin Jacobs Technion-Cornell Institute; inventor: Morad Tomer), there is disclosed a computing system and a method for self-tuning a computing system. The method includes executing a current workload of the computing system until completion of the current workload; measuring a current operation metric representing a current operation performance of the computing system; tuning each of the plurality of system knobs to a static value selected from a group of static values; and iteratively executing the current workload of the computing system until an exit condition is met, wherein the exit condition is met when operation of the computing system having the system knobs tuned to one of the selected static values is an optimal static value satisfying at least one predefined target metric.

Although such a method of the granted US patent U.S. Ser. No. 10/606,337B2 is applicable to optimize an operation of computer systems, it is not suitable for other types of systems, especially those types of systems whose operating parameters are diffuse in nature and less straightforward to quantify. For example, human beings are themselves systems that are susceptible to being continuously optimized using suitable feedback. However, obtaining a measure of performance of a human system is a complex task, wherein various types of questionnaires are contemporarily available for personal information gathering purposes, for example questionnaires for determining a wellbeing profile of a student (see Koulun Hyvinvointiprofiili) in a school are described in https://koulunhyvinvointiprofiili.fi/.

There are many similar yearly questionnaires. However, common to all of the questionnaires is that they do not support:

(i) continuous data collection;
(ii) personalized AI-based feedback; and
(iii) a dynamic wellbeing model based on AI algorithms.

### SUMMARY

The present disclosure seeks to provide an improved method for (namely, a method of) automatically continuously self-optimizing a system. Moreover, the present disclosure seeks to provide an apparatus for implementing the improved method.

According to a first aspect, there is provided a method for self-optimizing a system implementing a process (P), wherein the method uses a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system to be self-optimized,

characterized in that the method includes:

(a) using the computing arrangement to configure interrogating data for interrogating the system, and to apply the interrogating data to the system via the output interface;
(b) using the computing arrangement to collect corresponding measurement response data from the system via the input interface;
(C) using the computing arrangement to compute from the measurement response data one or more measured indicators (I) that are representative of operation of the system;
(d) using the computing arrangement to compare the one or more measured indicators (I) with one or more corresponding target indicators (T(I));
(e) using the computing arrangement to compute one or more corresponding performance gaps from a comparison in (d);
(f) using the computing arrangement to use the one or more performance gaps to select from the mathematical model one or more optimization routines that are able to optimize a performance of the system; and
(g) using the computing arrangement to apply via the output interface the one or more optimization routines to the system to optimize its performance.

The present disclosure is of advantage in that interrogating and measuring responses of the system in respect of the mathematical model enables one or more suitable optimization routine to be selected and applied to the system that are capable of optimizing operation of the system.

According to a second aspect, there is provided an apparatus for implementing a method for (namely, a method of) self-optimizing a system implementing a process (P), wherein the apparatus includes a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system to be self-optimized,

characterized in that the apparatus is configured:

(a) to use the computing arrangement to configure interrogating data for interrogating the system, and to apply the interrogating data to the system via the output interface;
(b) to use the computing arrangement to collect corresponding measurement response data from the system via the input interface;
(c) to use the computing arrangement to compute from the measurement response data one or more measured indicators (I) that are representative of operation of the system;
(d) to use the computing arrangement to compare the one or more measured indicators (I) with one or more corresponding target indicators (T(I));
(e) to use the computing arrangement to compute from a comparison in (d) one or more corresponding performance gaps;
(f) to use the computing arrangement to use the one or more corresponding performance gaps to select from the mathematical model one or more optimization routines that are able to optimize a performance of the system; and
(g) to use the computing arrangement to apply via the output interface the one or more optimization routines to the system to optimize its performance.

According to a third aspect of the disclosed embodiments, there is provided a computer program product comprising a non-transitory computer-readable storage medium having computer-readable instructions stored thereon, the computer-readable instructions being executable by a computerized device comprising processing hardware to execute a method of the first aspect.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a schematic illustration of a system that is susceptible to being optimized using a method of the present disclosure;

FIG. 1B is a schematic illustration of an interaction of an apparatus with a group of students for acquiring indicators representative of a state of wellbeing of the students, and providing feedback metrics to the students and their teachers;

FIG. 1C is a schematic illustration of an arrangement for use in schools for implementing the method pursuant to the present disclosure;

FIG. 2 is a schematic illustration of a process P, phenomena p of the process P, indicators I derived from measurements made of the process P, and target values T(I) for the indicators I that are to be achieved though application of the method of the present disclosure;

FIG. 3 is a schematic illustration of seven steps required to implement the method of the present disclosure;

FIG. 4 is a schematic illustration of student wellbeing that can be analyzed by representing the wellbeing as a process P defined by phenomena p and optionally sub-phenomena;

FIG. 5 is a schematic illustration of a system including an antenna having a tilt angle □ₜᵢₗₜ that is to be optimized using the method of the present disclosure;

FIG. 6 is a schematic illustration of the antenna of FIG. 5, wherein steps 1 and 2 of the method of the present disclosure are implemented;

FIG. 7 is a schematic illustration of the antenna of FIG. 5, wherein a step 3 of the method of the present disclosure is implemented;

FIG. 8 is a schematic illustration of the antenna of FIG. 5, wherein steps 4 and 5 of the method of the present disclosure are implemented;

FIG. 9 is a schematic illustration of the antenna of FIG. 5, wherein steps 6 and 7 of the method of the present disclosure are implemented; and

FIG. 10 is a schematic illustration of a flow chart illustrating seven steps required to implement the method of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, in a first aspect, the present disclosure provides a method for self-optimizing a system implementing a process (P), wherein the method uses a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system (10) to be self-optimized,

characterized in that the method includes:

(a) using the computing arrangement to configure interrogating data for interrogating the system, and to apply the interrogating data to the system via the output interface;
(b) using the computing arrangement to collect corresponding measurement response data from the system (10) via the input interface;
(c) using the computing arrangement to compute from the measurement response data one or more measured indicators (I) that are representative of operation of the system;
(d) using the computing arrangement to compare the one or more measured indicators (I) with one or more corresponding target indicators (T(I));
(e) using the computing arrangement to compute one or more corresponding performance gaps from a comparison in (d);
(f) using the computing arrangement to use the one or more performance gaps to select from the mathematical model one or more optimization routines that are able to optimize a performance of the system; and
(g) using the computing arrangement to apply via the output interface the one or more optimization routines to the system (10) to optimize its performance.

Optionally, the method includes arranging for the computing arrangement to implement a plurality of iterations of interrogating the system and receiving corresponding measurement response data from the system, wherein measurement response data of a given previous iteration is applied to the mathematical model to configure interrogating data for interrogating the system in a subsequent iteration following the given previous iteration, to generate updated versions of the received measured response data, wherein each iteration enables a choice of the one or more optimization routines to be dynamically temporally varied.

The method is capable of being used to optimize technical systems as well as people, and organized groups of people. Optionally, when using the method, the system is a given person, and the interrogating data includes a selection of interrogating questions to prompt the given person, wherein responses from the given person to the selection of interrogating questions provides the measurement response data. More optionally, when using the method, the computer arrangement is configured to compute a wellbeing of the given person from the mathematical model based, at least in part, on the performance gaps. Optionally, when using the method, the selection of interrogating questions is varied randomly by the computing arrangement so that a selection of questions is different for each iteration of interrogating the given person.

As aforementioned, the method is applicable to technical systems. Optionally, when using the method, the process (P) is an industrial process implemented using industrial apparatus and the received measured response data is sensed data obtained from sensing one or more stages of the industrial process. Optionally, when using the method, the one or more optimization routines are used to control operation of the process (P).

Optionally, when using the method, the system is an industrial apparatus and the received measured response data is sensed from one or more component parts of the industrial apparatus. For example, when using the method, the industrial apparatus is a wireless transceiver apparatus, wherein the received measured response data corresponds to measured wireless coverage of the wireless transceiver apparatus over a given spatial region. More optionally, when using the method, the one or more optimization routines via the output interface are used to adjust a tilt angle (□ₜᵢₗₜ) of an antenna of the wireless transceiver apparatus to optimize its performance.

Optionally, when using the method, the target indicator values T(I) are adjustable to optimize operation of the process (P).

Optionally, when using the method, the mathematical model is implemented using a recursive neural network arrangement that is capable of implementing iterative learning.

In a second aspect, the present disclosure provides an apparatus for implementing a method for self-optimizing a system implementing a process (P), wherein the apparatus includes a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system to be self-optimized,

characterized in that the apparatus is configured:

(a) to use the computing arrangement to configure interrogating data for interrogating the system, and to apply the interrogating data to the system via the output interface;
(b) to use the computing arrangement to collect corresponding measurement response data from the system via the input interface;
(c) to use the computing arrangement to compute from the measurement response data one or more measured indicators (I) that are representative of operation of the system;
(d) to use the computing arrangement to compare the one or more measured indicators (I) with one or more corresponding target indicators (T(I));
(e) to use the computing arrangement to compute from a comparison in (d) one or more corresponding performance gaps;
(f) to use the computing arrangement to use the one or more corresponding performance gaps to select from the mathematical model one or more optimization routines that are able to optimize a performance of the system; and
(g) to use the computing arrangement to apply via the output interface the one or more optimization routines to the system to optimize its performance.

According to a third aspect, the present disclosure provides a computer program product comprising a non-transitory computer-readable storage medium having computer-readable instructions stored thereon, the computer-readable instructions being executable by a computerized device comprising processing hardware to execute the method of the first aspect.

The present disclosure is therefore concerned with a method for self-optimizing a system, for example an automated method for continuously self-optimizing a system. The method is beneficially implemented using an apparatus that is used in combination with the system. Moreover, the method is applicable to systems that satisfy following constraints:

(a) the systems are capable of being further optimized, namely the systems are not already maximally optimized, to achieve an improved operating performance;
(b) measurements are susceptible to being made that provide information regarding how well the systems are performing; and
(C) a degree of reconfigurability is feasible to cause improvements in operating performance of the systems.

Systems that are susceptible to being improved by the aforesaid method include manufacturing facilities implementing manufacturing processes (for example mass-production of components), telecommunication systems and components (for example base stations, base station controllers, signal switches) that provide for wireless communication, a human system (namely, a person) whose health maintenance and wellbeing are required to be improved, as well as organizational systems that employ processes that need to be improved (for example, work practices, work values work targets).

In embodiments of the present disclosure, a method is employed that is based on following assumptions:

(i) a process P is to be managed;
(ii) an owner or user of the process P is desirous to improve a performance of the process P, wherein a performance improvement requires that measured performance indicators I representing the process P are as close to their target indicator values T(I) as possible;
(iii) the process P is susceptible to being interrogated or measured to generate a set of indicators I=I₁, . . . I_{N}, wherein “I” denotes an indicator, and “N” is a total number of indicators to be used for achieving continuous self-optimization;
(iv) for each indicator I, there is defined a corresponding target indicator value T(Iᵢ), wherein “i” is an integer in a range of 1 to N; the target values are beneficially set by an owner or user of the process P, wherein the target values T(Iᵢ) are potentially guided by standards, regulations or practices; and
(v) the process P is considered to be a combination of sub-processes p₁ to pₘ, wherein m is an integer. These sub-processes pₘ are conveniently referred to as being “phenomena”; for example, a very simple process P has only one phenomenon p₁ associated therewith, for example lights “ON” or “OFF”, bistate thermostats that control a room temperature, and so forth.

It will be appreciated that many processes P comprise a plurality of phenomena p₁ to p_{N}. Dividing a given process P into a plurality of phenomena p makes the given process P easier to analyze and optimize. In a perfect world, all the phenomena [p₁, p₂, . . . , p_{N}] are mutually independent (referred to as being “orthogonal”), but interdependencies often occur between the phenomena in a real-world situation. For example, if the process P is a process of maintaining good health (well-being) for a given person, the process P can be subdivided into phenomena p such as diet, physical health, mental health, safety and health services. These phenomena p mutually interact since poor mental health can result in poor diet arising on account of unsuitable nutritional choices made by the given person.

In order to provide continuous self-improvement, the method includes using one or more target indicators T(I), as aforementioned.

Therefore, from above, it will be appreciated that a human being is also a system that is susceptible to being continuously self-optimized using the method of the present disclosure. From a human perspective, it will be appreciated that human wellbeing is a global concern. However, it will be also appreciated that wellbeing concerns are addressable both in economically well-performing countries as well as in poor countries. According to a PISA report where “Student Wellbeing” is one of the key topics, every country has challenges with student emotional health, school life, bullying, receiving support, and learning environment; responses to these are susceptible to being optimized using the method of the present disclosure.

However, a problem that is encountered, for example in a school environment, is a lack of concrete data. Contemporarily, wellbeing is typically measured by students completing questionnaires only once per year. Data obtained via use of such questionnaires is found to be representative of only a miniscule part of a given student's life.

A problem arising in classrooms in schools is that teachers often have no visibility regarding how their students are emotionally reacting to different learning situations. Additionally, there is often a loud minority of students that expresses its wellbeing issues and emotions, but many students in need remain silent and may not be instructed to get professional help in time. As a result, self-harm and suicide can sometimes be a consequence of unaddressed wellbeing issues. At a personal level, student personal problems vary considerably within a given group of students. In a worst-case situation, a student may develop a feeling that he or she is left alone with a burdensome situation and is unaware from where help can be sought.

Beneficially, the method of the present disclosure can be used to optimize different types of human systems, wherein the method includes following steps:

(i) using artificial intelligence (AI) or machine learning (ML) to model wellbeing phenomena p;
(ii) using AI-guided collection of information and data from students and teachers;
(iii) using computers to compute indicator values I that are representative of a state of the students; and
(iv) comparing the indicator values I against corresponding target values T(I) to provide feedback to the students and their teachers in such a manner that an iterative optimization occurs for the students and teachers.

For implementing embodiments of the present disclosure, there is employed an apparatus comprising a computing arrangement including one or more data processors coupled in communication with data memory. Advantageously, the one or more data processors are implemented as multiple-core processors capable of performing parallel processing, for example multiple-core processors as manufactured by Intel Corp. The computing arrangement is provided with artificial intelligence software that, when executed on the one or more data processors, simulates recursive neural networks that are capable of learning a sequence of events as well as making decisions based on values of input parameters as well as one or more previous decision steps taken by the recursive neural network. In the recursive neural network, the more often a given decision path of the neural network is invoked, the more the decision path is reinforced.

When implementing embodiments of the present disclosure, for example for providing continuous optimization of wellbeing for a given person such as a student or teacher, certain component parts are required for the embodiments, as follows:

(a) a mathematical model of a system to be optimized is required, wherein the mathematic model has a representation of the process P and its associated one or more phenomena p; for example, the mathematical model is configured as being a wellbeing model expressed in a language that is understood by a software-based artificial intelligence (AI) engine, wherein the wellbeing model includes interrogating questions to be used as interrogating data for different ages of students and teachers for deriving corresponding indicators I. Moreover, the mathematical model includes indicators I that are calculated based on answers provided to the interrogating questions. There are utilized fuzzy rules used in the mathematical model that trigger a sequence of interrogating questions that are used to interrogate the students or teachers to determine their state and thereby derive the indicators I;
(b) an artificial intelligence (AI) engine that can be configured to compute the aforesaid mathematical model, wherein the AI engine is capable when in operation of composing and sending interrogating questions to students and teachers according to the mathematical model (for example, by selecting question elements from within a pre-defined library of potential interrogating questions). Answers to the interrogating questions are analyzed by the AI engine to determine corresponding indicators I. Such an indicator, for example, is a value that is calculated based on answers to 1 to Q questions, in a time period of a duration D; optionally, the time period of duration D is typically a week or month and is chosen to have a length of duration that filters out spurious instantaneous noise from the answers by computing indicators I that provide a reliable representation;
(c) the AI engine is able to calculate feedback to be sent to various parties, for example to students and/or teachers, providing conclusions of mathematical models that are imported into the computing system. The conclusions can include, for example, guidance or advice that can be used by the students and/or teachers to improve their performance for optimization purposes; and
(d) the AI engine is capable of maintaining a log of the indicators I as they change as a function of time t, as well as a log of interrogating questions posed by the computing system and corresponding answers; optionally, the log includes user information, school information, class information as well as managing access rights to the information.

Embodiments of the present disclosure are beneficially implemented as cloud-based solutions, namely using computing arrangements that are hosted via the Internet®, for example hosted at server centres, data centres and such like.

### DETAILED DESCRIPTION OF THE DIAGRAMS

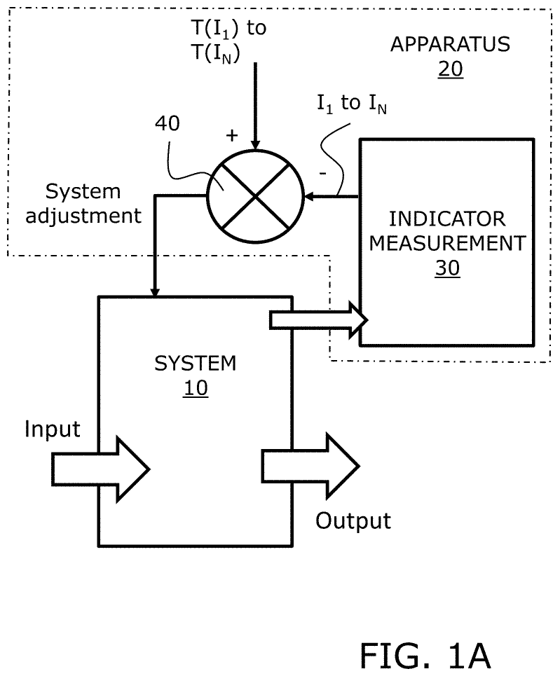

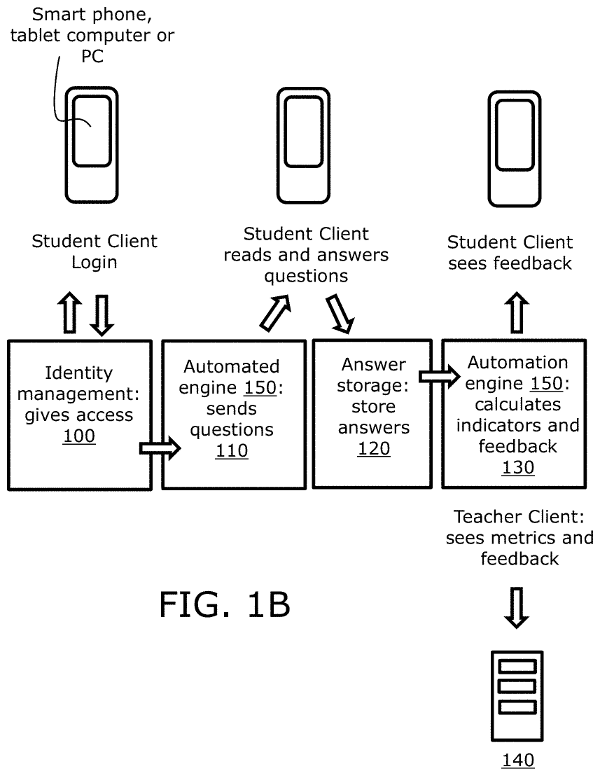

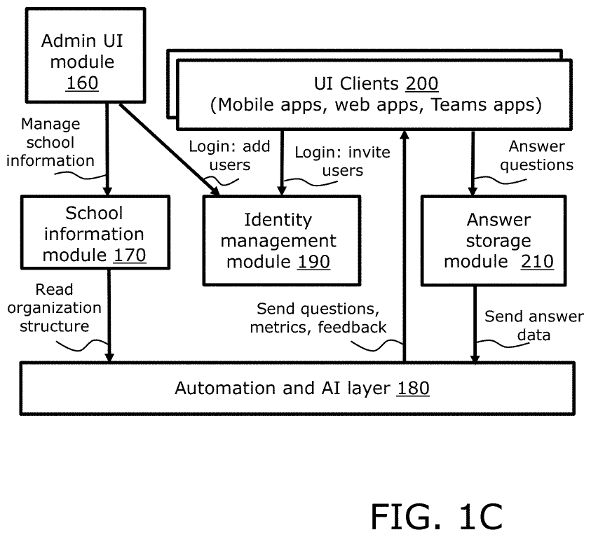

Referring to FIG. 1A, there is shown a system 10 that is to be optimized using the method of the present disclosure. The system 10 functions, when in operation, to receive inputs and to generate outputs. The outputs are monitored by an apparatus 20 that includes an indicator measurement arrangement 30 that is used to compute indicators I that are representative of operation of the system 10. Differences between the indicators I and their corresponding target indicators T(I) are computed by a comparator 40 included in the apparatus 20, wherein the differences correspond to performance gaps, wherein the differences are used to make adjustments to parameters of the system 10 so that it functions more optimally.

In practice, the apparatus 20 can be configured in various ways, depending on a nature of the system 10 to be optimized.

For example, as illustrated in FIG. 1B, an identity management arrangement 100 provides login information for students to access the apparatus 20 via their mobile telephones; the students in such a situation represent the system 10 that is to be optimized. An automation engine 150 generates one or more interrogating questions 110 that are communicated to the students that provide one or more corresponding answers (namely one or more responses) to the one or more interrogating questions, wherein the one or more answers are stored in data memory as denoted by 120. The automation engine 150 then analyses the one or more corresponding answers and computes therefrom indicators that are representative of a wellbeing of the students as well as feedback. The indicators and feedback are reported back to the students as well as metrics 140 are communicated to their corresponding teachers.

In other words, the apparatus 20 can be configured to send daily interrogating questions to the group of students, for example via their smart phones. From answers provided by the students, the apparatus 20 is capable of using its mathematical model to compute wellbeing and SEL metrics for the group of students and their school. Output parameters provided by the apparatus 20 are able to provide the students with feedback to optimize their performance at the school, and teachers and district leaders are able to determine from the output parameters 140 student wellbeing and SEL analytics.

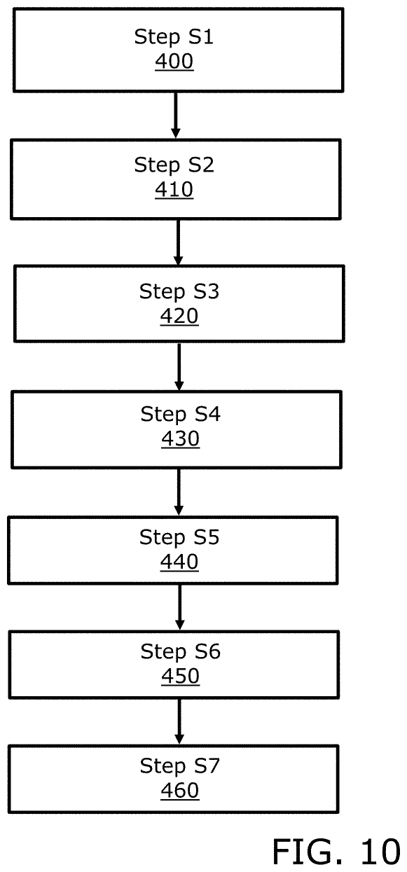

Referring next to FIG. 10, there is shown an implementation of the aforesaid apparatus 20 when used for optimizing wellbeing of students in a school environment. The apparatus 20 includes an administration user interface module 160 (“admin UI module”) that generates information for managing the school, wherein the generated information is communicated to a school information module 170 to provide organization structure information to an automation and AI layer 180. The administration user interface 160 also generates login data that is required for adding users to the apparatus 20, wherein the login data is communicated to an identity management module 190. User interface clients 200, for example students, are invited to join the apparatus 20 via operation of the identify management module 190. The students receive interrogating questions, metrics and feedback from the automation and AI layer 180, and respond back by answering the interrogating question whose response data is stored in an answer storage module 210, and answer data is sent from the answer storage module 210 to the automation and AI layer 180. Storing the answers enables a database to be generated that is useful for training the automation and AI layer 180.

It will be appreciated from FIG. 10 that there is considerable data flow within the apparatus 20 when it is in operation. The data flow is valuable for teachers, school principals and district leaders to be able to analyze indicators and distributions of answers to individual interrogating questions that are sent to the students. Of distinguishing significance in FIG. 10 is that the apparatus 20 employs AI-based computed feedback to the students.

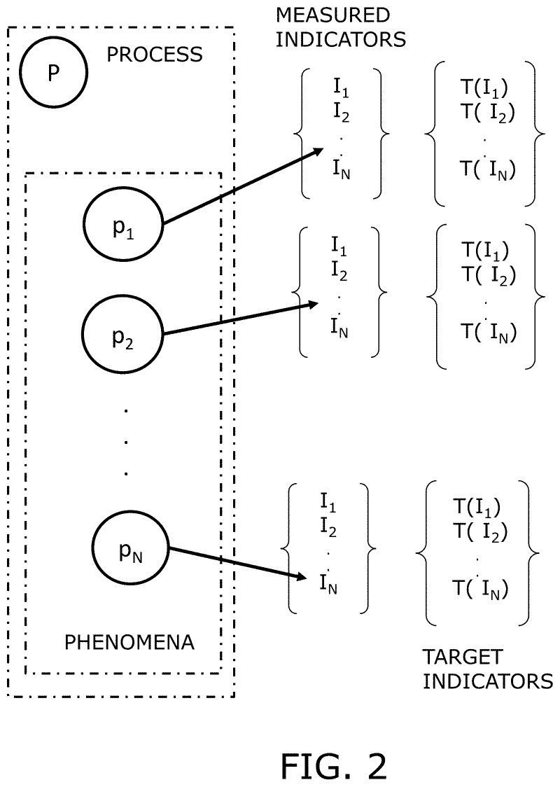

Referring next to FIG. 2, the apparatus 20 interfacing to the system 10 is configured on an assumption that the system 10 is utilizing a process P when in operation. The process P is beneficially regarded as being a set of phenomena denoted by p₁ to p_{N}, wherein N is an integer. The apparatus 20, when in operation, computes indicators I for each of the phenomena p from results of interrogation applied to the system 10. The apparatus 20 is also supplied with a set of target indicators T(I) for each phenomenon p. For example, the phenomena p can be characteristics of the students being questioned as depicted in FIG. 10. The apparatus 20 seeks to guide the system 10 so that its indicators I are steered towards attaining values of the target indicators T(I).

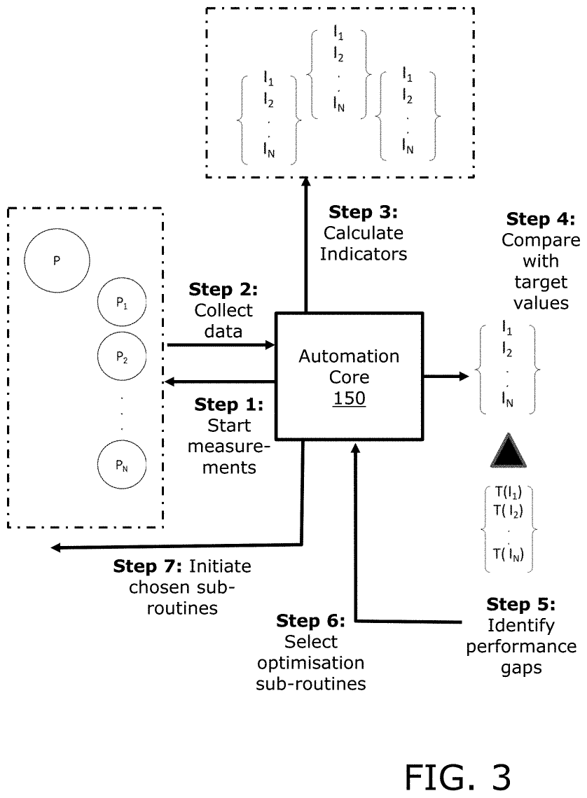

Referring next to FIG. 3, the apparatus 20 employs as an essential feature an automation core 150. The automation core 150 employs a series of steps, namely Steps 1 to 7, to interrogate the system 10. In the step 1, the automation engine 150 starts performing measurements on the system 10 to determine information about the phenomena p₁ to p_{N} by collecting data from the system 10 as denoted by the step 2. The automation core 150 then calculates the indicators I to IN from the collected data. Thereafter, in the step 4, the automation core compares the calculated indicators with the target values T(I) to identify performance gaps and then optimization subroutines accordingly in the step 6 for applying to the system 10 to optimize its operation. It will be appreciated that the apparatus 20 may take several cycles of iterations before the system 10 is fully optimized.

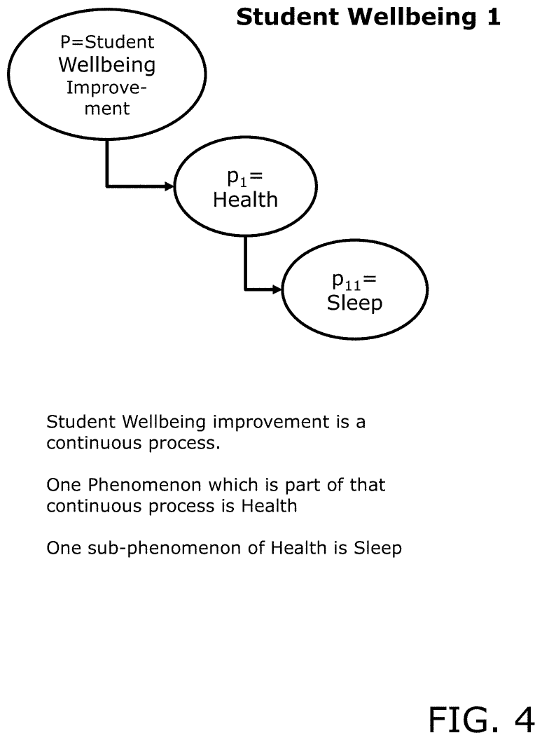

Referring next to FIG. 4, when the apparatus 20 is optimizing a given student as being the system 10, it is convenient for the apparatus 20 to consider the students as a process P, and to determine multiple layers of phenomena p as a hierarchical structure, for example the process P is student wellbeing, and an associated phenomenon p₁ is health that has a sub-phenomenon of sleep.

When configuring the apparatus 20, certain preparatory steps are required to be executed:

(i) Wellbeing specialists create a mathematical model that defines wellbeing phenomena, wellbeing interrogation questions, indicators as well as feedback sentences with rules that trigger the feedback;
(ii) The mathematic model is conveniently written with descriptive modeling language (files); and
(iii) Model files that define the mathematical model are imported to automation engine 150 that functions as an artificial intelligence (AI) component

When using the apparatus 20, user data has to be set as follows:

(iv) e-mail addresses, user log-ins or anonymous logins are registered to the administration user interface module 160; and
(v) users of the apparatus 20 are, via the user interface module 160, able to download software applications to their mobile computing devices, for example smart phone, tablet computers and similar; alternatively, the users are able to use a browser-based user interface for interacting with the system 20.

When in operation, the automation engine 150 of the apparatus 20 sends sets of interrogating questions to each user of the apparatus 20. Beneficially, such interrogating questions are sent 1 to 2 times each day. The users, for example students and teachers, respond promptly when receiving the interrogating questions. The automation engine 150 is capable of functioning according to one of two modes of operation when interfacing to a given user:

(a) a first mode A wherein the interrogating questions are selected by the automation engine 150 in a random manner from a pre-prepared library of interrogating questions; and
(b) a second mode B wherein the interrogating questions are selected by the automation engine 150 based on a previous wellbeing history of the given user. In the second mode, the interrogating questions are selected to give priority to areas where the where the given user is likely to have issues (for example, a tendency towards anorexia or depression). Thus, responses from the given user can be focused towards determining measured indicators for comparison with target indicators to address performance gaps of the given user that require special attention.

The apparatus 20 is able to provide its users with notification regarding new interrogating questions for which user-responses are required. Moreover, the apparatus 20 is able to check that the interrogating questions are being answered by way of user-responses, and that the user-responses are stored in data memory for subsequent analysis.

Beneficially, the automation engine 150 processes the answers every night, to avoid any backlog of data accumulating within the apparatus 20. Such processing involves scaling and normalization of data; such scaling and normalization is required to cope with mutually different significances of features, for example bullying is more severe then cleanliness of toilets in a life of a student. In a preparation phase, the automation engine 150 calculates indicators I from the interrogating questions and corresponding user-responses. The indicators I can be at various levels, for example at a general school level, at a class level or at an individual student level. At an individual level, the indicators I can be teacher-focused or student-focused. Optionally, the indicators I are calculated based on the user's answers to one or more interrogating questions during a defined time period during which responses to questions can be provided to the apparatus 20; the defined time duration is, for example, a week or a month. Moreover, it will be appreciated that the indicators can be calculated using various mathematical functions, for example an average, a weighted average, a trend and so on. Based on indicators and answers to various interrogating questions, the automation engine 150 provides feedback messages determined by one or more rules programmed into the automation engine 150. Optionally, fuzzy logic rules are employed in the automation engine 150; for example, “if an indicator A is HIGH and an indicator B is LOW, then send feedback X”.

Aforesaid feedback is beneficially sent via one or more messages privately and anonymously to client users of the apparatus 20; the one or more messages are beneficially password protected to maintain user privacy. Moreover, the system 20 allows class-level and school-level answer distributions to be visualized in a user portal provided by the apparatus 20, for example via a business interface portal.

In operation, a user of the apparatus 20 experiences the apparatus 20 in a following manner:

(i) a teacher informs the user that the user's class is now using the apparatus 20 and a corresponding solution that it provides;
(ii) the user installs a solution client to his or her mobile telephone (for example by using contemporary software such as Teams® or a browser);
(iii) the user receives a notification via his or her smart phone that, for example, ten interrogating questions have been sent for the user to provide response answers;
(iv) the user answers the ten interrogating questions in a period of only 20 seconds;
(v) a day later, the apparatus 20 sends one or more professional feedback messages to the user's smart phone about the user's state of wellbeing, wherein the user's state of wellbeing is based on the user's responses to the ten interrogating questions as well as answers provided from the user's student colleagues in a same class as the user, and wherein the feedback messages are informative, motivating, encouraging and supporting.

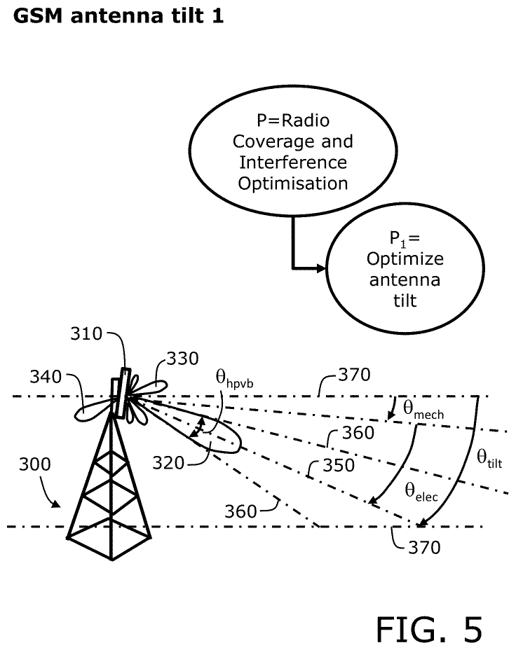

Although use of the apparatus 20 to optimize student wellbeing is described in the foregoing, it will be appreciated that the method of the disclosed embodiments implemented by the apparatus 20 is also applicable to industrial machinery and industrial apparatus. Referring to FIG. 5, there is shown a wireless mast indicated generally by 300. At an upper end of the mast 300 is mounted an antenna 310. When in operation, the antenna 310 emits and receives electromagnetic radiation, for example at a frequency in an order of 1 GHz. However, a tilt angle □ₜᵢₗₜ of the antenna 310 is important in operation to ensure that the wireless mast is able to provide wireless communication coverage while not creating wireless radiation pollution, for example at wireless network cell boundaries. Important factors include a mechanical tilt angle □_{mech} relative to a horizontal 370 and a principal lobe angle denoted by □_{elec}, from which an angle of a principal emission direction 350 can be determined. Half power band limits are denoted by 360. Although the antenna 310 exhibits a principal lobe 320, the antenna also has side lobes 330, 340 that can give rise to spurious received signals and can cause electromagnetic radiation pollution. Adjusting the tilt angle □ₜᵢₗₜ of the antenna 310 when in operation is important for optimizing operation of the wireless mast 300 and its associated equipment.

Adjusting the antenna tilt angle □ₜᵢₗₜ is a dynamic way to optimise radio conditions in telecommunications systems. Modern antennae do not need an on-site-visit for tilt angle □ₜᵢₗₜ adjustments to be performed. Such tilt angle □ₜᵢₗₜ adjustment can be implemented remotely from an Operations Center using software tools that send signals to remote actuators of the antennae, for example. A too high antenna tilt angle □ₜᵢₗₜ causes pilot pollution and a poor coverage/intensity (C/INT) ratio, which leads to lower data throughput in wideband wireless communication. A too low antenna tilt angle □ₜᵢₗₜ causes coverage gaps and failed handovers when mobile telephones spatially move from one wireless cell to another. Changing traffic patterns are also potentially a reason for a need to change antennae adjustments, for example adjusting the tilt angle □ₜᵢₗₜ. For example, during office hours, an optimal tilt angle □ₜᵢₗₜ is potentially different to an optimal title angle □ₜᵢₗₜ for evenings when there is less traffic.

Remote adjustment of antenna tilt angle □ₜᵢₗₜ is feasible to implement, for example wherein the antenna 310 is implemented as a phased array or implemented with a mechanically adjustable mechanical mount with actuators, as aforementioned. It will also be appreciated that a too high antenna tilt causes pilot pollution and poor coverage relative to intensity ratio (C/INT), resulting in lower data throughput in wideband radio communication. Conversely, a low antenna tilt angle □ₜᵢₗₜ causes coverage gaps at boundaries of wireless cells and resulting failed handovers, for example when mobile telephones are moved from a range of the mast 300 to a range of another neighbouring mast. Changing traffic patterns sensed by the system 10 are potentially beneficial to take into account when the automation core 150 is used to optimize the tilt angle □ₜᵢₗₜ of the antenna 310.

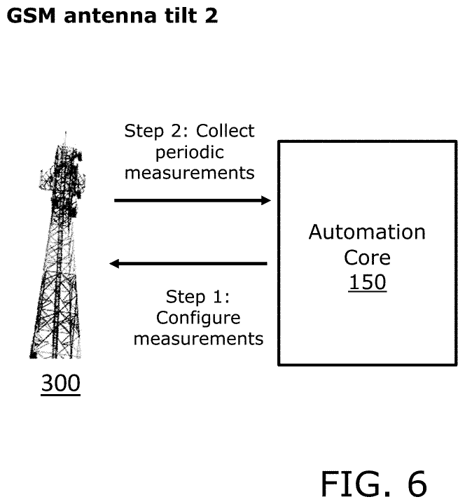

Referring to FIG. 6, when optimizing the tilt angle □ₜᵢₗₜ of the antenna 310 as depicted in FIG. 5, the automation core 150 applies the step 1 to configure measurements to be made on the antenna 310 and its mast 300. Beneficially, in the step 2, the measurements are made at regular intervals, for example daily or hourly, to optimize the antenna 310 using the automation core 150.

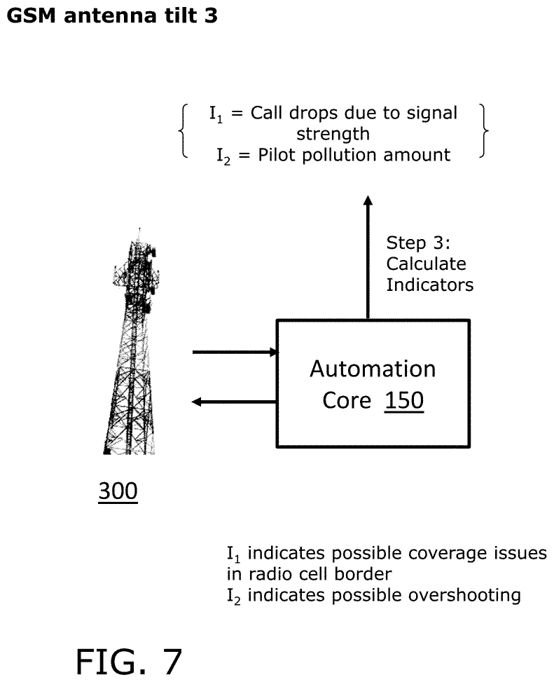

Referring to FIG. 7, in the step 3, the automation core 150 computes using its mathematic model of the antenna 310 values for indicators I₁ and I₂, wherein the indicator I₁ is representative of mobile telephone call drops arising due to wireless coverage issues at wireless cell borders present in a wireless network, and the indicator I₂ is representative of pilot pollution amounts due to overshooting when providing wireless communication coverage.

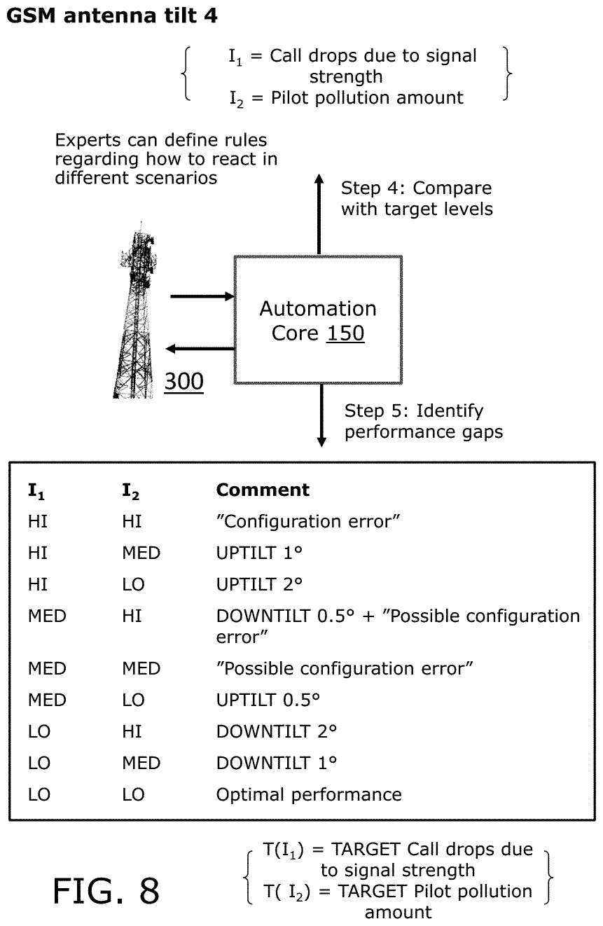

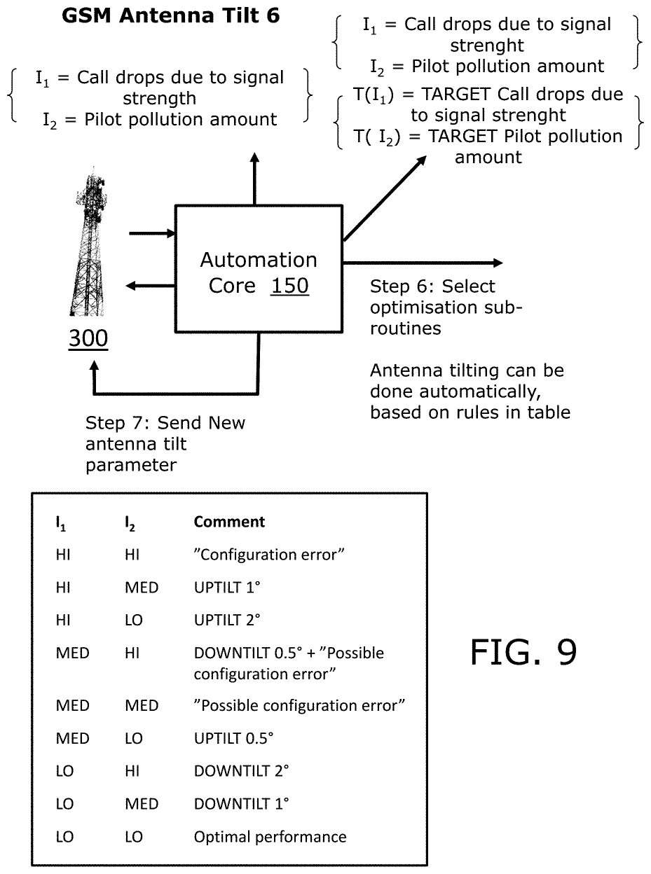

Referring next to FIGS. 8 and 9, after the indictors I₁ and I₂ have been computed in the step 3, the automation core 150 compares the indicator values calculated in the step 4 with corresponding target indicator values T(I). A difference between the calculated indicators and the target indicators enables performance gaps to be computed in the step 5. The automation core 150 then applies these performance gaps to its mathematic model in the step 6, wherein the mathematical model is pre-programmed with various rules or taught various rules on account via its AI engine, to select one or more suitable optimization sub-routines. In the step 7, one or more chosen optimization sub-routines are initiated and executed to adjust the antenna 310, for example adjusting its tile angle □ₜᵢₗₜ, to optimize an operating performance of the mast 300. In the step 7, optimization adjustments of the tilt angle □ₜᵢₗₜ are implemented to improve and optimize operation of the mast 300.

For convenience, the indicators I₁ an I₂ can be coarsely categorized into three discrete categories: high (HO), medium (MED) and low (LO). Rules are beneficially provided or taught into the automation core 150 how to adjust the mast 300 and its antenna 310 to provide an optimization as outlined in the tables in FIGS. 8 and 9.

Referring next to FIG. 10, there are shown seven steps of the method of the present disclosure, when executed using the apparatus 20. The method is used for self-optimizing a system 10 implementing a process (P), wherein the method uses a computing arrangement (represented by the apparatus 20 and its associated automation engine 150) including a processing arrangement and data memory coupled thereto, wherein the computing arrangement includes an output interface for interrogating the system 10 and an input interface and for receiving measurement responses from the system 10 respectively, wherein the computing arrangement includes a mathematical model of the system 10 to be self-optimized.

In a step S1 denoted by 400, the computing arrangement is used to configure interrogating data for interrogating the system 10, and to apply the interrogating data to the system 10 via the output interface.

In a step S2 denoted by 410, the computing arrangement is used to collect corresponding measurement response data from the system 10 via the input interface.

In a step S3 denoted by 420, the computing arrangement is used to compute from the measurement response data one or more measured indicators (I) that are representative of operation of the system 10.

In a step S4 denoted by 430, the computing arrangement is used to compare the one or more measured indicators (I) with one or more corresponding target indicators (T(I)).

In a step S5 denoted by 440, the computing arrangement is used to compute one or more corresponding performance gaps from a comparison in the step S4.

In a step S6 denoted by 450, the computing arrangement is configured to use the one or more performance gaps to select from the mathematical model one or more optimization routines that are able to optimize a performance of the system 10.

In a step S7 denoted by 460, the computing arrangement is used to apply via the output interface the one or more optimization routines to the system 10 to optimize its performance.

Modifications to embodiments of the present disclosure described in the foregoing are possible without departing from the scope of the disclosed embodiments as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method for self-optimizing a system implementing a process (P), wherein the method uses a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system to be self-optimized, wherein the method includes:
(a) using the computing arrangement to configure interrogating data for interrogating the system, and to apply the interrogating data to the system via the output interface;
(b) using the computing arrangement to collect corresponding measurement response data from the system via the input interface;
(c) using the computing arrangement to compute from the measurement response data one or more measured indicators (I) that are representative of operation of the system;
(d) using the computing arrangement to compare the one or more measured indicators (I) with one or more corresponding target indicators (T(I));
(e) using the computing arrangement to compute one or more corresponding performance gaps from a comparison in (d);
using the computing arrangement to use the one or more performance gaps to select from the mathematical model one or more optimization routines that are able to optimize a performance of the system; and
(g) using the computing arrangement to apply via the output interface the one or more optimization routines to the system to optimize its performance.

2. A method of claim 1, wherein the method includes arranging for the computing arrangement to implement a plurality of iterations of interrogating the system and receiving corresponding measurement response data from the system, wherein measurement response data of a given previous iteration is applied to the mathematical model to configure interrogating data for interrogating the system in a subsequent iteration following the given previous iteration, to generate updated versions of the received measured response data, wherein each iteration enables a choice of the one or more optimization routines to be dynamically temporally varied.

3. A method of claim 2, wherein the system is a given person, and that the interrogating data includes a selection of interrogating questions to prompt the given person, wherein responses from the given person to the selection of interrogating questions provides the measurement response data.

4. A method of claim 3, wherein the computer arrangement is configured to compute a wellbeing of the given person from the mathematical model based, at least in part, on the performance gaps.

5. A method of claim 3, wherein the selection of interrogating questions is varied randomly by the computing arrangement so that a selection of questions is different for each iteration of interrogating the given person.

6. A method of claim 1, wherein the process is an industrial process implemented using industrial apparatus and the received measured response data is sensed data obtained from sensing one or more stages of the industrial process.

7. A method of claim 6, wherein the one or more optimization routines are used to control operation of the process (P).

8. A method of claim 1, wherein the system is an industrial apparatus and the received measured response data is sensed from one or more component parts of the industrial apparatus.

9. A method of claim 8, wherein the industrial apparatus is a wireless transceiver apparatus, wherein the received measured response data corresponds to measured wireless coverage of the wireless transceiver apparatus over a given spatial region.

10. A method of claim 9, wherein the one or more optimization routines via the output interface are used to adjust a tilt angle (□ₜᵢₗₜ) of an antenna of the wireless transceiver apparatus to optimize its performance.

11. A method of claim 1, wherein the target indicator values T(I) are adjustable to optimize operation of the process (P).

12. A method of claim 1, wherein the mathematical model is implemented using a recursive neural network arrangement that is capable of implementing iterative learning.

13. An apparatus for implementing a method for self-optimizing a system implementing a process (P), wherein the apparatus includes a computing arrangement including a processing arrangement and data memory coupled thereto, wherein the computing arrangement includes an output interface for interrogating the system and an input interface and for receiving measurement responses from the system respectively, wherein the computing arrangement includes a mathematical model of the system to be self-optimized,
wherein the apparatus is configured:
(a) to use the computing arrangement to configure interrogating data for interrogating the system, and to apply the interrogating data to the system via the output interface;
(b) to use the computing arrangement to collect corresponding measurement response data from the system via the input interface;
(c) to use the computing arrangement to compute from the measurement response data one or more measured indicators (I) that are representative of operation of the system;
(d) to use the computing arrangement to compare the one or more measured indicators with one or more corresponding target indicators (T(I));
(e) to use the computing arrangement to compute from a comparison in (d) one or more corresponding performance gaps;
(f) to use the computing arrangement to use the one or more corresponding performance gaps to select from the mathematical model one or more optimization routines that are able to optimize a performance of the system; and
(g) to use the computing arrangement to apply via the output interface the one or more optimization routines to the system to optimize its performance.

14. A computer program product comprising a non-transitory computer-readable storage medium having computer-readable instructions stored thereon, the computer-readable instructions being executable by a computerized device comprising processing hardware to execute a method as claimed in claim 1.
